(19) United States
(12) Patent Application Publication
(10) Pub. No.: US 2013/0241927 A1
(43) Pub. Date: Sep. 19, 2013

(54) COMPUTER DEVICE IN FORM OF WEARABLE GLASSES AND USER INTERFACE THEREOF

(71) Applicant: Neorai Vardi, Mevaseret Tzion (IL)

(72) Inventor: Neorai Vardi, Mevaseret Tzion (IL)

(21) Appl. No.: 13/893,697

(22) Filed: May 14, 2013

Related U.S. Application Data
(63) Continuation-in-part of application No. 13/366,322, filed on Feb. 5, 2012.
(60) Provisional application No. 61/504,210, filed on Jul. 3, 2011.

(51) Int. Cl. G02B 27/01

(52) U.S. Cl. CPC G02B 27/017
USPC 345/419; 345/8; 345/168

(57) ABSTRACT

A computer device that is configured as wearable glasses and a user interface thereof, which comprises a transparent optical lens adapted to display, whenever desired, visual content on at least a portion of the lens, for enabling a user wearing the glasses to see the visual content, wherein the lens enables a user to see there through, in an optical manner, also a real-world view; a wearable frame for holding the lens and a portable computerized unit for generating the visual content and displaying or projecting the visual content on the portion, wherein the computerized unit is embedded within the frame or mounted thereon.

The current application claims the benefit of U.S. Provisional Patent Application No. 61/504,210, filed 3 Jul. 2011, incorporated herein by reference.

### FIELD OF THE INVENTION

The present invention relates to the field of computer devices and user interface thereof. More particularly, the invention relates to a user interface for a computer device that is configured as wearable glasses.

### BACKGROUND OF THE INVENTION

The term user interface refers to facilities and functionality for allowing interaction between a human user and a computerized machine. The purpose of a user interface is to allow a human user to monitor and/or control the computerized machine. For these purposes, a user interface may include inputting facilities such as keyboard and mouse, and/or to display the output from the computer, such as video signals and audio signals.

Video glasses (also known as data glasses or visor) are a recently developing output facility. It comprises two displays, embedded in a glasses form device. Thus, a user that wears video glasses can watch a video display, such as a movie. Video glasses are common as an output device for video games and military simulators. However, when a human user wears such glasses there is an obstacle to using a keyboard with hands or to perform other tasks, as this video glasses block the vision their through.

It is an object of the present invention to provide a solution to the above-mentioned and other problems of the prior art.

Other objects and advantages of the invention will become apparent as the description proceeds.

### SUMMARY OF THE INVENTION

In order to facilitate the reading to follow, the following terms are defined:

The terms “desktop computer”, “computer device” or shortly “computer” refer herein to any computer that employs a user interface comprising an output facility such as a display and input facility in the form of an alphanumeric keyboard, whether real or virtual.

The present invention relates to a computer device that is configured as wearable glasses and a user interface thereof, which comprises:
at least one transparent optical lens adapted to display, whenever desired, visual content on at least a portion of said lens, for enabling a user wearing said glasses to see said visual content, wherein said lens enables a user to see there through, in an optical manner, also a real-world view;
a wearable frame for holding said lens; and
a portable computerized unit for generating said visual content and displaying or projecting said visual content on said portion, wherein said computerized unit is embedded within said frame or mounted thereon.

According to an embodiment of the invention, the computer device further comprises a keyboard substitute which includes: a virtual keyboard (20) (and/or other virtual input device, such as a computer mouse) displayed on said portion; and at least one sensor (14) for indicating the state and position of each of the fingers of a user, with reference to an image that represent said virtual keyboard; thereby providing a user interface in the form of video glasses for the computer device.

According to an embodiment of the invention, the at least one sensor (14) is embedded within a glove (12).

According to an embodiment of the invention, the computer device further comprises built-in earphones (60), connected to the wearable frame, for being used as an output facility of the computer device.

According to an embodiment of the invention, the computer device further comprises a microphone (24) embedded in the wearable frame, for being used as an input facility to the computer device.

According to one embodiment of the invention, the computer device further comprises a pointing device (e.g., in form of a computer mouse or trackball) in a wired or wireless communication with the portable computerized unit.

According to yet another embodiment of the invention, a substantial part of the circuitry of the portable computerized unit is embedded in an external device, wherein said external device is connected to said computer device via a wired or wireless communication channel (e.g., I/O port, USB connection, Bluetooth, etc.).

According to an embodiment of the invention, the computer device may further comprise circuitry and/or computer code for analyzing human speech and translating thereof to computer instructions.

According to another embodiment of the invention, the computer device enable to see their through, in a digital manner, a real-world view (e.g., a camera allows to take a video stream and display or superimpose it on the lens).

According to one embodiment of the invention, the computer device adapted to generate stereoscopic images (i.e., a different image is displayed to each eye), thereby allowing presenting 3D images.

According to one embodiment of the invention, the computer device further comprises a projector (22), for projecting visual content generated by the portable computerized unit on an essentially flat surface in front of the computer device. According to an embodiment of the invention, the projected visual content includes at least one virtual input device such as a virtual keyboard and/or a virtual computer mouse.

According to one embodiment of the invention, the computer device further comprises at least one sensor for indicating the state and position of each of the fingers of a user, with reference to the projected virtual input device(s).

According to one embodiment of the invention, the computer device further comprise an I/O port (e.g., a USB connector and circuitry), for allowing connecting additional peripherals to said computer device (e.g., via the portable computerized unit).

According to one embodiment of the invention, the computer device further comprises a memory slot (30) and circuitry, for allowing connecting a memory (28), such as a an electronic flash memory data storage device used for storing digital information, to said computer device.

According to one embodiment of the invention, the computer device further comprises at least one camera (whether stills or video), for inputting video signals. According to one embodiment of the invention the camera is a rear camera (i.e., internal camera) for transmitting multimedia information that shows at least portion of the face of the user wearing the computer device.

According to one embodiment of the invention, the computer device further comprises a cellular module (e.g., a cellular telephone circuitry), embedded in the wearable frame, thereby providing said computer device the ability of cellular communication (e.g., allowing using the computer device as a cellular telephone).

According to one embodiment of the invention, the computer device is powered by one or more rechargeable batteries, wherein said batteries can be recharged by solar energy via solar panel or manually via a charger with manual hand ankle.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a computer device that is configured as wearable glasses and a user interface thereof, according to one embodiment of the invention.

FIG. 2 schematically illustrates peripheral devices that can be connected to the computer device of FIG. 1, according to embodiments of the present invention.

FIG. 3 schematically illustrates further peripheral devices that can be connected to the computer device of FIG. 1, according to one embodiment of the invention.

FIG. 4 schematically illustrates a usage of the computer device of FIG. 1 as a part of a cellular telephone, according to one embodiment of the invention.

It should be understood that the drawings are not necessarily drawn to scale.

### DETAILED DESCRIPTION OF THE EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

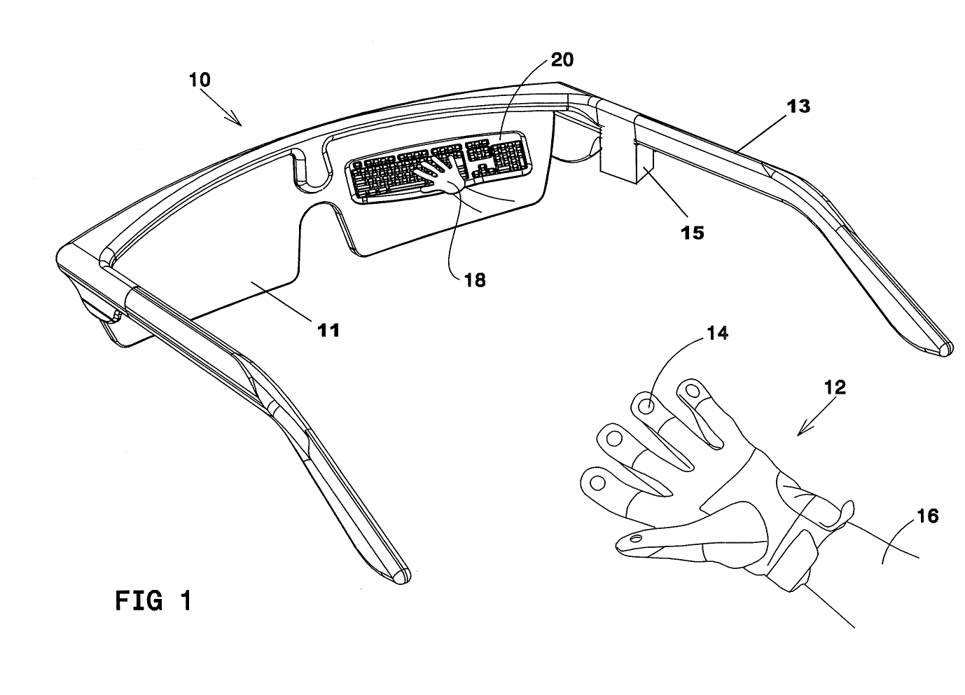

FIG. 1 schematically illustrates a computer device 10 that is configured as wearable glasses and a user interface thereof, according to one embodiment of the invention. The computer device 10 comprises: at least one transparent optical lens 11, a wearable frame 13 for holding lens 11 and a portable computerized unit 15.

The at least one transparent optical lens 11 adapted to display, whenever desired, visual content on at least a portion of lens 11, for enabling a user wearing the computer device 10 to see the visual content on the portion of the lens 11 that is directed to the user's eyes. In addition, lens 11 enables the user to see there through, in an optical manner, also a real-world view. The lens 11 is used as a display of the computer device 10.

Portable computerized unit 15 is used for generating the visual content and for displaying or projecting the generated visual content on the portion of lens 11. Portable computerized unit 15 can be embedded within the wearable frame 13 or mounted thereon as shown in the figures. According to one configuration (not illustrated), the portable computerized unit is embedded in the wearable frame 13. Of course, such configuration requires ultimate minimization of the components thereof. The ear bars of the wearable frame 13 may be used as housing for batteries.

According to one embodiment of the invention, portable computerized unit 15 may include all the computer's components (e.g., graphic card, CPU, memory, etc.) required for generating the visual content and for displaying or projecting the generated visual content on the portion of lens 11. In this embodiment, portable computerized unit 15 combines the computer's components (e.g., in a suitable circuitry form) into the same wearable frame 13 that holds the lens 11. As will be appreciated by a person skilled in the art, portable computerized unit 15 may combine only part of the computer's components, as described in further details hereinafter.

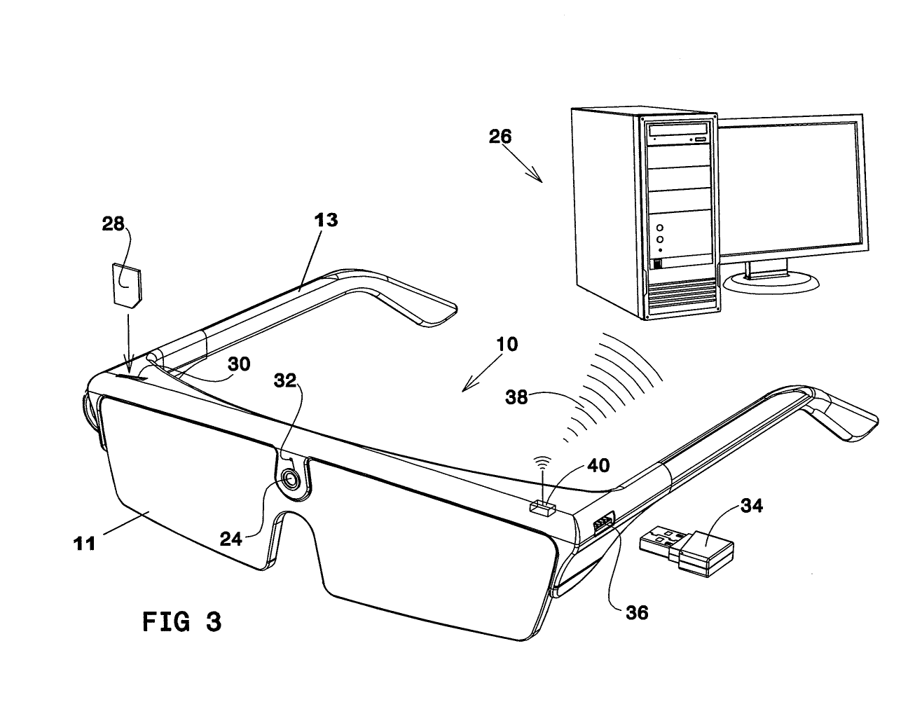

According to an embodiment of the invention, substantial part of the circuitry of the portable computerized unit 15 is embedded in an external device (not shown). The external device is connected to the computer device 10 (i.e., to the corresponding circuitry of the portable computerized unit 15 that remains embedded with frame 13) via a wired or wireless communication channel (e.g., I/O port, USB connection, Bluetooth, etc.). For example, the external device can be implemented as a portable device (e.g., a desktop computer embedded in a chip in a similar manner as shown with respect to a portable device 34 in FIG. 3 hereinafter), or as a connection box (e.g., similar to a desktop computer 26 as shown with respect to FIG. 3 hereinafter).

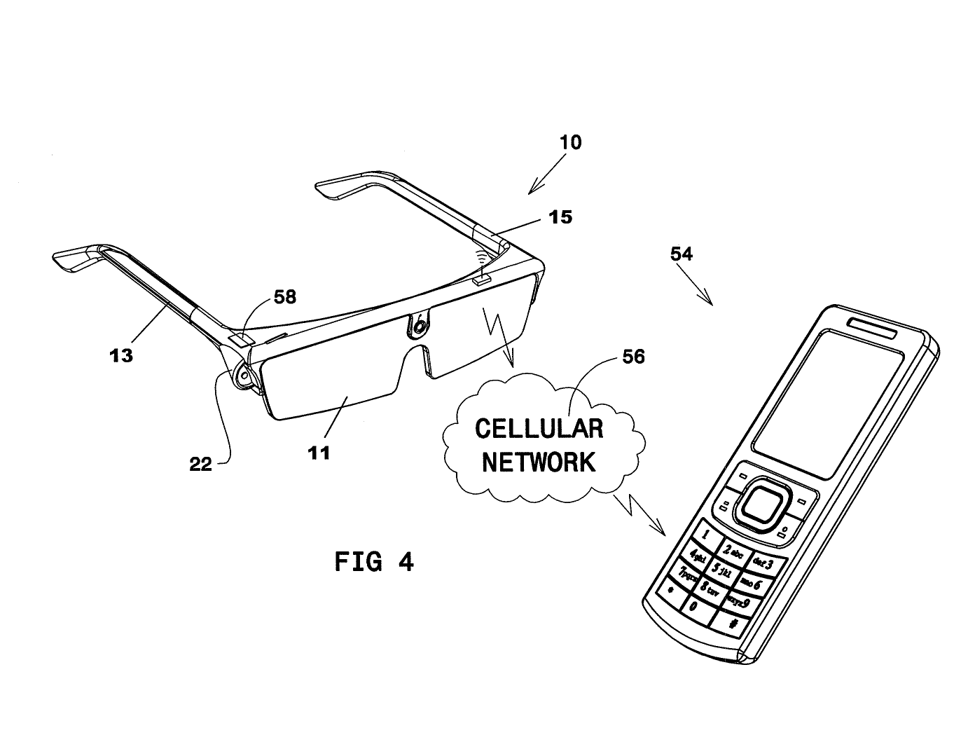

According to an embodiment of the invention, the computer device 10 further comprises a keyboard substitute which includes: a virtual keyboard (20) displayed on the portion of lens 11 (or projected as described hereinafter in further details with respect to projector 22 of FIG. 4), and at least one sensor (14) for indicating the state and position of each of the fingers of a user's hand (16), with reference to an image that represent the virtual keyboard 20. The keyboard substitute can provide a user interface in the form of video glasses for the computer device 10. As per the keyboard, as a user may not see the real world through prior-art video glasses, a “real” keyboard (i.e., tangible keyboard) cannot be useful.

For example, as a substitute to a real keyboard, computer device 10 displays (or projects) a virtual keyboard 20 and at least one virtual glove 18 (or alternatively other virtual pointing device, such as a virtual computer mouse). In addition, the user wears a real glove 12 on his palm, which comprises sensors 14 on each of the fingers thereof, for sensing (a) the state of each of the fingers of the glove, and (b) the absolute and/or relative position of each of the fingers thereof with reference to an imaginary keyboard (not illustrated).

As the user moves glove 12 with reference to the imaginary keyboard, the virtual glove 18 imitates this movement. As a user “hits” by the finger of the glove (e.g., performs a sudden movement downwards), the computer interprets this event as hitting the key of the virtual keyboard 20 at which the virtual finger of virtual glove 18 points. The display of the virtual glove 18 may animate the key hit, e.g., by a blink.

The imaginary keyboard may be embodied as a landmark device 62 placed in front of the user. The landmark device 62 and the glove 12 comprise circuitry for indicating the location of each of the sensors 14 on the glove 12 with reference to the landmark device 62.

It should be noted that if the landmark device 62 would have been a part of the computer device 10, the mechanism for indicating the location and state of each of the sensors 14 on the fingers of the glove 12 would have been more complicated, as the computer device is not stationary. A landmark device 62 placed in a stationary location simplifies the mechanism.

Although in the figures only one glove is displayed, according to a preferred embodiment of the invention, two gloves can be used, as typing on a keyboard is usually effected by two hands. Alternatively, the user may use sensors 14 without gloves (e.g., a sensor implemented as a wearable finger ring).

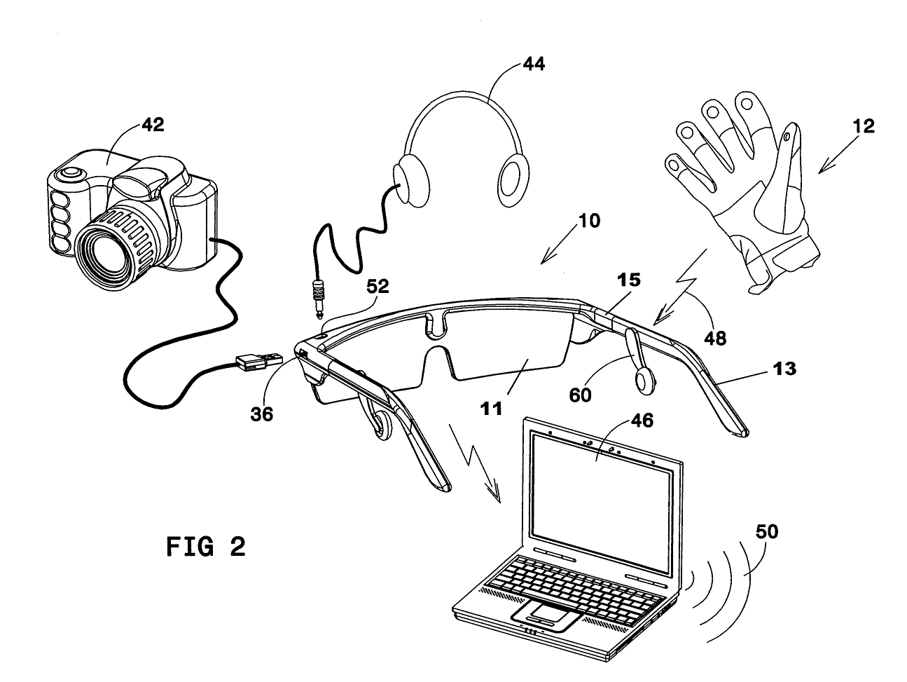

FIG. 2 schematically illustrates peripheral devices that can be connected to the computer device 10, according to embodiments of the present invention.

The computer device 10 may comprise built-in earphones 60, connected to the ear bars of frame 13.

Additionally or alternatively, the computer device 10 may comprise external earphones 44 connected to the computer device 10 through a corresponding connector 52 embedded within frame 13.

The computer device 10 may also comprise a USB (Universal Serial Bus) connector 36, through which a USB camera 42 and the like can be connected.

Glove 12 can communicate with the computer device 10 by Bluetooth communication 48.

Computer device 10 can be connected to a wireless network 50, to a laptop computer 46, and so on.

FIG. 3 schematically illustrates further peripheral devices that can be connected to the computer device 10, according to an embodiment of the invention.

A slot 30 on the frame of computer device 10 may be used for connecting external memory to computer device 10, and also therefrom (e.g., via a wired or wireless communication link) to a desktop computer 26 thereof.

According to one embodiment of the invention, computer device 10 further comprises a camera (whether stills or video), for inputting video signals. In this figure, an Internet camera 32 and built-in microphone 24 are connected to the front of the computer device 10, thereby allowing transmitting multimedia information sensed by the individual wearing the computer device 10. In other embodiment, an additional camera (not shown), can be connected to the internal side of computer device 10 (i.e., a rear camera), thereby allowing transmitting multimedia information that shows at least portion of the face of the individual wearing the computer device 10 (e.g., this can be used for videoconferencing).

FIG. 3 also schematically illustrates some configurations of a desktop computer system that employs the computer device 10.

According to a first configuration, the computer device 10 is a user interface output facility of desktop computer 26. For this purpose, the computer device 10 is connected with desktop computer 26 via RF (Radio Frequency) signal 38, such as Bluetooth communication, Wi-Fi communication, digital network interface for wireless High-Definition signal transmission (e.g., WirelessHD), and the like. Bluetooth is an open specification for short-range wireless communication between various types of communication devices, such as cellular telephones, pagers, hand-held computers, and personal computers. In such configuration, the display of the desktop computer 26 can be replaced by the computer device 10. For example, the such configuration can be used as media streaming system, where multimedia content from desktop computer 26 streamed to computer device 10.

According to a second configuration, the desktop computer system is a portable device 34, which connects to the computer device via USB connector 36. In such configuration, device 34 can be used instead of the portable computerized unit 15 of FIG. 1.

According to a third configuration (not illustrated), the desktop computer is embedded in the wearable frame 13. Of course, such configuration requires ultimate minimization of the components thereof. The ear bars of the wearable frame 13 may be used as housing for batteries. According to one embodiment, the batteries can be recharged by solar energy via solar panel (not shown) or manually via a charger with manual hand ankle such as the Sony CP-A2LAS Charger.

According to a fourth configuration (not illustrated), the computer device 10 is connected to desktop computer 26 by wired communication means.

FIG. 4 schematically illustrates a usage of computer device 10 as a part of a cellular telephone, according to one embodiment of the invention.

A cellular telephone circuitry (not illustrated) is embedded in the frame 13 of computer device 10. The cellular telephone circuitry uses the display of computer device 10 (i.e., lens 11), built-in microphone (24) and built-in earphones (60). Thus, a user wearing computer device 10 can engage in a cellular telephone conversation with a user of cellular telephone 54.

The cellular telephone embedded in computer device 10 communicates with cellular telephone 54 via cellular network 56.

Actually, cellular telephones are presently designed to perform operations of desktop computing, and vice versa. As such, there is no point in distinguishing between a cellular telephone that provides only telephone functionality and a cellular telephone that also provides functionality of a desktop computer.

According to one embodiment of the invention, computer device 10 may further comprise a projector (22), for projecting the visual content generated by the portable computerized unit 15 on an essentially flat surface (e.g., movies, media files or documents in front of the computer device). For example, in such configuration the computer device 10 can be used as a media streamer. Projector 22 may also be used to project visual content such as images that simulate the required devices to operate computer application manually, such as a virtual computer mouse (not shown), the virtual keyboard 20 described hereinabove with respect to FIG. 1, etc. For example, designated software adapted to recognize the user's hand(s) or fingers in a surface defined as an auxiliary device surface can be used. This can be done by using motion sensors backed by a configuration recognition software and/or surface locating and mapping for surface part software, while addressing the location of the projected virtual mouse (or virtual keyboard) and translating them for various operations commands for the computer device 10.

In the figures and/or description herein, the following reference numerals have been mentioned:
numeral 10 denotes computer device in form of wearable glasses, used as a computer and a display thereof;
numeral 11 denotes a transparent optical lens;
numeral 12 denotes a glove having thereon sensors 14;
numeral 13 denotes a wearable glasses frame;
numeral 14 denotes a sensor (either on a finger of glove 12 or not), used for indicating the position (i.e., on which key of a keyboard it points) and state (pressed or not) thereof;
numeral 15 denotes a portable computerized unit;
numeral 16 denotes a user's hand;
numeral 18 denotes a virtual glove (or palm) displayed on a display of computer glasses 10;
numeral 20 denotes a virtual keyboard displayed on a display of computer glasses 10;
numeral 22 denotes a projector, for projecting the content displayed on the display of computer glasses 10, on a flat surface;
numeral 24 denotes a microphone embedded in a frame of computer glasses 10;
numeral 26 denotes a desktop computer;
numeral 28 denotes a memory card;
numeral 30 denotes a slot and circuitry, through which a memory can be added to a desktop computer connected to or embedded in the computer glasses 10;
numeral 32 denotes an Internet camera;
numeral 34 denotes a desktop computer embedded in a chip, such as a smart card;
numeral 36 denotes a USB connector in a frame of computer glasses 10;
numeral 38 denotes an RF (Radio Frequency) signal, such as a Bluetooth signal;
numeral 40 denotes an RF transceiver;
numeral 42 denotes a camera;
numeral 44 denotes external earphones connected to computer glasses 10 through a corresponding connector 52;
numeral 46 denotes a laptop computer, connected to computer glasses 10;
numeral 48 denotes a Bluetooth communication signal;
numeral 50 denotes a wireless network;
numeral 52 denotes an earphones connector;
numeral 54 denotes a cellular telephone;
numeral 56 denotes a cellular network;
numeral 58 denotes a cellular transceiver, embedded in computer glasses 10;
numeral 60 denotes built-in earphones; and
numeral 62 denotes a landmark device to be placed in front of a user.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1) A computer device (10) that is configured as wearable glasses and a user interface thereof, comprising:
at least one transparent optical lens (11) adapted to display, whenever desired, visual content on at least a portion of said lens, for enabling a user wearing said glasses to see said visual content, wherein said lens enables a user to see there through, in an optical manner, also a real-world view;
a wearable frame (13) for holding said lens; and
a portable computerized unit (15) for generating said visual content and displaying or projecting said visual content on said portion, wherein said computerized unit is embedded within said frame or mounted thereon.

2) A computer device according to claim 1, further comprises a keyboard substitute which includes: a virtual keyboard (20) displayed on said portion; and at least one sensor (14) for indicating the state and position of each of the fingers of a user, with reference to an image that represent said virtual keyboard;
thereby providing a user interface in the form of video glasses for the computer device.

3) A computer device according to claim 2, in which the at least one sensor (14) is embedded within a glove (12).

4) A computer device according to claim 1, further comprises built-in earphones (60), connected to the wearable frame, for being used as an output facility of the computer device.

5) A computer device according to claim 1, further comprises a microphone (24) embedded in the wearable frame, for being used as an input facility to the computer device.

6) A computer device according to claim 1, further comprises a pointing device in a wired or wireless communication with the portable computerized unit.

7) A computer device according to claim 1, in which a substantial part of the circuitry of the portable computerized unit is embedded in an external device, wherein said external device is connected to said computer device via a wired or wireless communication channel.

8) A computer device according to claim 1, further comprises circuitry and/or computer code for analyzing human speech and translating thereof to computer instructions.

9) A computer device according to claim 1, in which the lens enable to see their through, in a digital manner, a real-world view.

10) A computer device according to claim 1, in which the computer device further adapted to generate stereoscopic images (i.e., a different image is displayed to each eye), thereby allowing presenting 3D images.

11) A computer device according to claim 1, in which further comprise a projector (22), for projecting visual content generated by the portable computerized unit on an essentially flat surface in front of the computer device.

12) A computer device according to claim 11, in which the projected visual content includes a virtual input device such as a virtual keyboard and/or a virtual computer mouse.

13) A computer device according to claim 12, further comprises at least one sensor for indicating the state and position of each of the fingers of a user, with reference to the projected virtual input device.

14) A computer device according to claim 1, further comprises an I/O port and circuitry, for allowing connecting additional peripherals to said computer device.

15) A computer device according to claim 1, further comprises a memory slot (30) and circuitry, for allowing connecting a memory (28) to said computer device.

16) A computer device according to claim 1, further comprise at least one camera (whether stills or video), for inputting video signals.

17) A computer device according to claim 15, in which the camera is a rear camera for transmitting multimedia information that shows at least portion of the face of the user wearing said computer device.

18) A computer device according to claim 1, further comprises a cellular module, embedded in the wearable frame, thereby providing said computer device the ability of cellular communication.

19) A computer device according to claim 1, in which said computer device is powered by one or more rechargeable batteries, wherein said batteries can be recharged by solar energy via solar panel or manually via a charger with manual hand ankle.
